(19) United States
(12) Patent Application Publication
(10) Pub. No.: US 2012/0208519 A1
(43) Pub. Date: Aug. 16, 2012

(54) Cellphone to Car Ignition

(76) Inventor: Matthew Seaver, Dunedin, FL (US)

(21) Appl. No.: 13/307,692

(22) Filed: Nov. 30, 2011

Related U.S. Application Data
(60) Provisional application No. 61/442,911, filed on Feb. 15, 2011.

(51) Int. Cl. H04W 4/04

(52) U.S. Cl. 455/420

(57) ABSTRACT

An architecture is presented that provides a system for controlling vehicle systems via a cellular phone. The system comprises a cellular phone and a vehicle. The cellular phone comprises a transceiver for transmitting a signal to a vehicle system of the vehicle. Further, the vehicle system comprises a transceiver for receiving the signal from the cellular phone. The user can configure the cellular phone and vehicle to communicate by linking the communications system of the cellular phone and the vehicle system. In response to detecting a communications signal from the cellular phone, the vehicle system then receives user input from the cellular phone. The user input is then linked to at least one command that controls the features and systems of the vehicle. Thus, the vehicle can be configured to perform certain actions or tasks based on a specific input or action taken by the user.

### CROSS-REFERENCE

This application claims priority from Provisional Patent Application Ser. No. 61/442,911 filed Feb. 15, 2011.

### BACKGROUND

Many drivers do not like using keys to start their vehicle. If a driver misplaces his or her keys, the driver is unable to start the ignition of the vehicle. Also, in the winter, many individuals would prefer to start their vehicle remotely and/or perform other vehicle actions remotely so that the vehicle can begin to heat up before they get in the vehicle. Currently, drivers have to have an automatic starter installed in their vehicle and have to carry around a small remote in order to start the vehicle, and the automatic starter only controls the ignition on the vehicle and typically serves no other purpose. Also, this requires the user to be within a certain distance of the vehicle when he or she starts it to ensure that the vehicle is receiving the signal from the remote. Many times, the individual thinks that their vehicle has been started only to find out that the vehicle never received the signal. An effective solution is necessary.

There is a need for a cell phone to car ignition system that is designed to allow individuals to start their vehicle's ignition and perform other vehicle actions with their cellular phone. The present invention discloses a system that enables individuals to start their vehicle's ignition and perform other vehicle actions by dialing a specific phone number or code from their cellular phone. The cellular phone will then beep to alert the user that the vehicle has been started and/or other action has been performed. The invention eliminates the need to use keys to start the engine or perform other vehicle actions and enables individuals, among other things, to start their vehicle remotely and turn off the engine when necessary.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a system for controlling vehicle systems via a cellular phone. The system comprises a cellular phone and a vehicle. The cellular phone comprises a transceiver for transmitting a signal to a vehicle system of the vehicle. Further, the vehicle system comprises a transceiver for receiving the signal from the cellular phone. The user can configure the cellular phone and vehicle to communicate by linking the communications system of the cellular phone and the vehicle system. In response to detecting a communications signal from the cellular phone, the vehicle system then receives user input from the cellular phone. For example, the vehicle system can receive a voice command, keyed entry, or button sequence as user input from the cellular phone. The user input is then linked to at least one command that controls the features and systems of the vehicle. Thus, the vehicle can be configured to perform certain actions or tasks based on a specific input or action taken by the user.

Furthermore in the preferred embodiment of the present invention, the vehicle system will send a signal back to the cellular phone to alert users that the vehicle action has been performed. Additionally, the vehicle can comprise an emergency stop button. The emergency stop button can be used by a user to stop the vehicle action that is being performed.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective (pictorial) view of a system for controlling vehicle systems from a cellular phone in accordance with the disclosed architecture.

FIG. 2 illustrates a block diagram of a cellular phone and vehicle system in accordance with the disclosed architecture.

FIG. 3 illustrates a perspective view of the cellular phone wherein a user enters a code in accordance with the disclosed architecture.

FIG. 4 illustrates a perspective view of the cellular phone wherein a user pushes a button in accordance with the disclosed architecture.

FIG. 5 illustrates a perspective view of the cellular phone receiving a signal that the vehicle engine has been started in accordance with the disclosed architecture.

FIG. 6 illustrates a perspective view of the emergency stop button of the system in accordance with the disclosed architecture.

FIG. 7 illustrates a perspective view of the system in use in accordance with the disclosed architecture.

FIG. 8 illustrates a method of remote starting a vehicle.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention discloses a cell phone to car ignition system that is designed to allow individuals to start their vehicle's ignition and perform other vehicle actions with their cellular phone by dialing a specific phone number or code from their cellular phone. The cellular phone will then alert the user that the vehicle has been started or action has been performed. The user configures the cellular phone and vehicle to communicate by linking the communications system of the cellular phone and the vehicle system. In response to detecting a communications signal from the cellular phone, the vehicle system then receives user input from the cellular phone. The user input is then linked to at least one command that controls the features and/or systems of the vehicle. Thus, the vehicle can be configured to perform certain actions or tasks based on a specific input or action taken by the user.

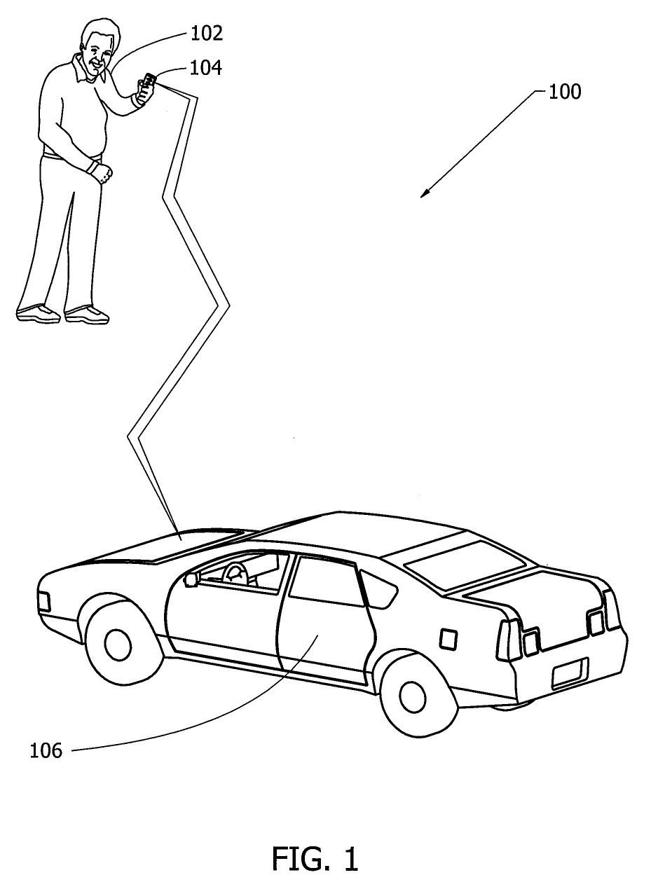

Referring initially to the drawings, FIG. 1 illustrates a system 100 for controlling vehicle systems via a cellular phone. The system 100 comprises a vehicle 106 which can be any transportation device, mechanism, or element suitable for transporting a user 102 from one location to another, as is known in the art, such as a car, truck, van, motorcycle, boat, plane, etc. The vehicle 106 comprises a motor or combustion engine, and a vehicle system (not shown), the vehicle system is typically the centralized computer system or vehicle bus of the vehicle 106. The vehicle system controls any number of vehicle systems including locks, lights, temperature controls, engine start and stop controls, alarm systems, trunk controls, environmental controls, etc. The vehicle system can also include a user interface, global positioning system (GPS), stereo or other vehicle elements configured for wireless communication.

Furthermore, the system 100 comprises a cellular phone 104. The cellular phone 104 is a device configured for wireless communications and can include smart phones, tablets, and other suitable wireless communications devices as is known in the art without affecting the overall concept of the invention. Additionally, the cellular phone 104 and the vehicle 106 can include hardware, software, and firmware configured for remote and wireless communication between the two devices. The cellular phone 104 may communicate with the vehicle 106 via any number of transmission signals, protocols, or standards, such as Bluetooth, WiFi, analog signals, etc., as is known in the art without affecting the overall concept of the invention. Further, the cellular phone 104 and the vehicle 106 may utilize communications services available through one or more networks operated by a communications service provider. The cellular phone 104 can be configured to control features, functions, or systems of the vehicle 106 automatically, based on preset user preferences, configurations, options, or based on user input received in real-time, or a combination thereof.

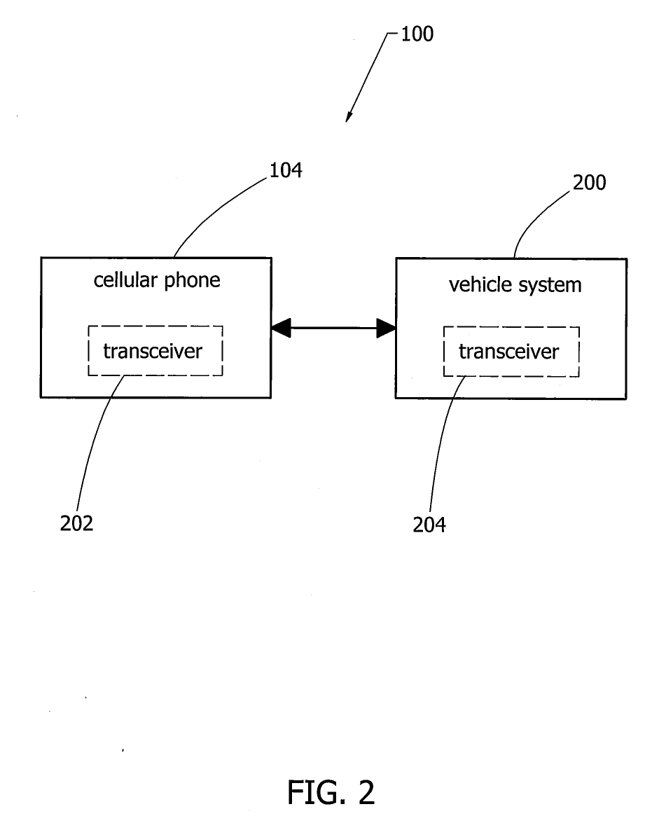

Specifically, FIG. 2 illustrates the system 100 for controlling vehicle systems via a cellular phone 104, wherein the cellular phone 104 comprises a transceiver or signal transmitter 202 for transmitting a signal to the vehicle system 200. Further, the vehicle system 200 comprises a transceiver 204 for receiving the signal from the cellular phone 104. The user can configure the cellular phone 104 and vehicle to communicate by linking the communications system of the cellular phone 104 and the vehicle system 200. For example, an application may be downloaded on the cellular phone 104, and/or a unique identifier for both the cellular phone 104 and the vehicle 106 may be registered with each of the respective devices to enable secure communications. The vehicle system 200 can also be configured to automatically search for a wireless signal from the cellular phone 104. In response to detecting the cellular phone 104, the vehicle system can take any number of actions. In response to detecting a communications signal from the cellular phone 104, the vehicle system then receives user input from the cellular phone 104 via a user interface. For example, the vehicle system 200 can receive a voice command, keyed entry, or button sequence as user input from the cellular phone 104. The user input is then linked to at least one command that controls the features and systems of the vehicle. Thus, the vehicle can be configured to perform certain actions or tasks based on a specific input or action taken by the user.

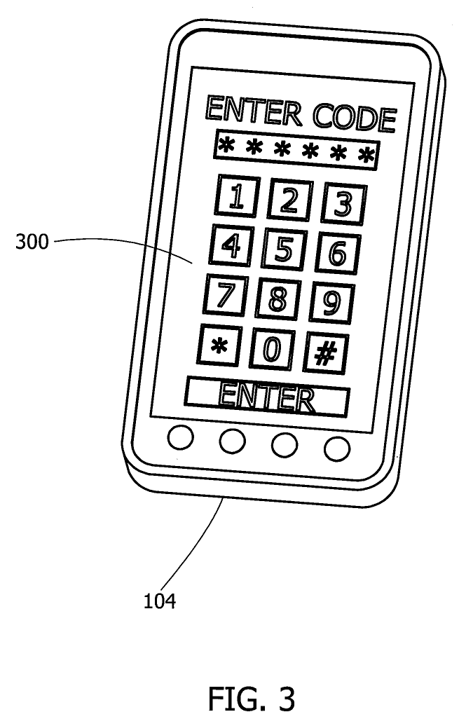

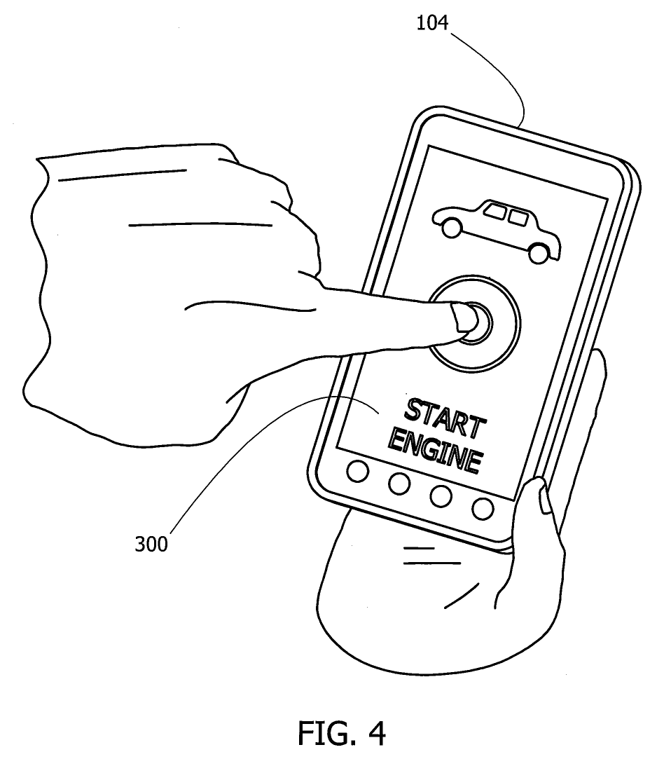

FIGS. 3 and 4 illustrate the user interface 300 of the cellular phone 104, wherein the user interface 300 is operable to receive user input. The user input comprises a keyed entry, a voice command, a button depression, or any other suitable input as is known in the art without affecting the overall concept of the invention. For example, FIG. 3 illustrates a user interface 300 depicting a keypad for a user to enter a code and FIG. 4 illustrates a user interface 300 depicting a push button for a user to push. The user interface 300 links the user input to at least one user command. The user commands are operable to translate into at least one vehicle action. The vehicle action comprises turning on and off the ignition system of the vehicle, locking or unlocking doors, rolling up and down windows, turning on and off vehicle lights, turning on and off windshield wipers, or any other suitable vehicle action as is known in the art without affecting the overall concept of the invention. Furthermore, the vehicle action can also comprise controlling a user's pre-sets for the vehicle, wherein the pre-set's comprise positioning of the vehicle's mirrors for a specific user, positioning of the vehicle's seats for a specific user, tilting of the vehicle's steering wheel for a specific user, adjusting the vehicle's temperature settings for a specific user, or adjusting the vehicle's radio volume or settings for a specific user. The user's pre-sets can be predetermined and a user activating the corresponding user command would be able to control the pre-sets via the user interface 300 of the cellular phone 104. Additionally, the user interface can comprise an identifier for authenticating the user input before transmitting the command to the vehicle system. The identifier can be a voice identifier, password, user name, a biometric or other keyed entry or any other suitable identifier as is known in the art without affecting the overall concept of the invention.

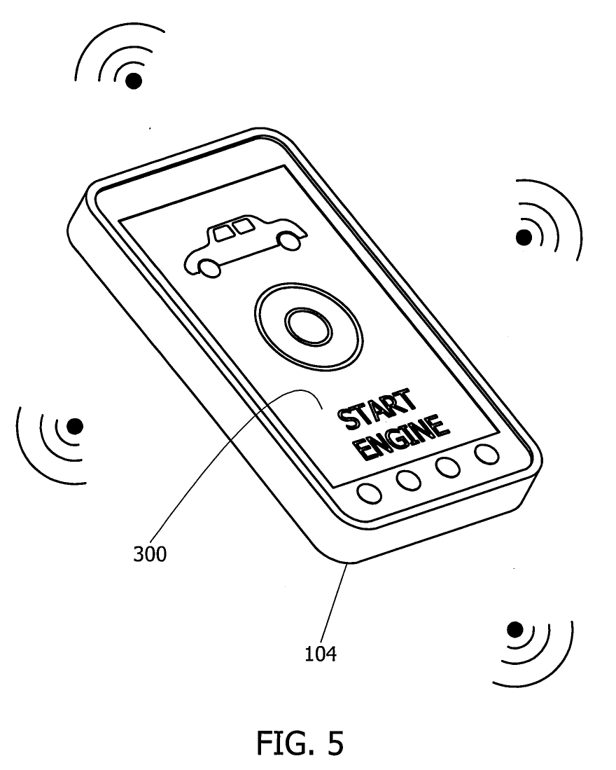

Furthermore, as shown in FIG. 5, in a preferred embodiment, the cellular phone emits a signal when the command has been performed. The signal is a beep, a buzz, a vibration, a ring, or any other suitable signal as is known in the art without affecting the overall concept of the invention. Specifically, entering a user input into the user interface 300 will send a signal to the vehicle system which will perform a vehicle action. The vehicle system will then send a signal back to the cellular phone 104 to alert users that the vehicle action has been performed.

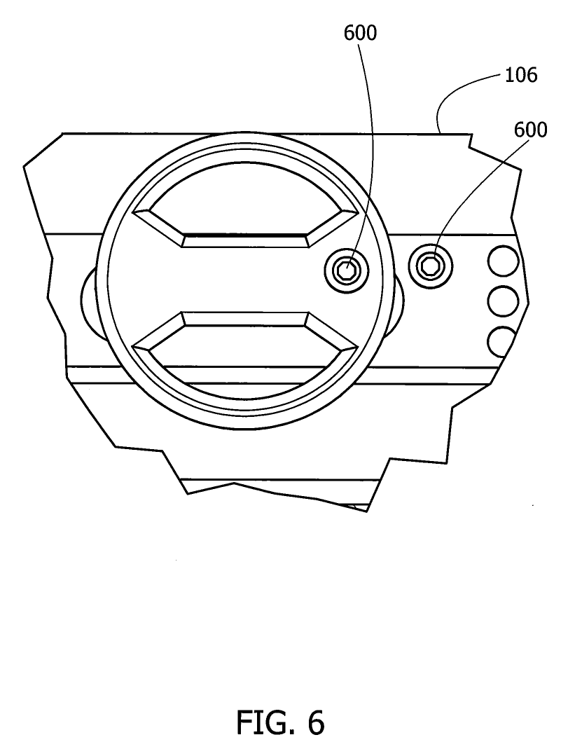

Additionally, FIG. 6 illustrates the emergency stop button 600 of the vehicle 106. The emergency stop button 600 can be located on the dashboard or the steering wheel or both locations, or any other suitable location as is known in the art without affecting the overall concept of the invention. The emergency stop button 600 can be used by a user to stop the vehicle action that was being performed.

Furthermore, the system for controlling vehicle systems from a cellular phone could also comprise a carbon monoxide detector which would detect levels of carbon monoxide within a vehicle or immediately adjacent to the vehicle. And, once a threshold level of carbon monoxide is detected, the vehicle ignition would automatically shut off. Specifically, the vehicle would comprise a carbon monoxide sensor positioned on the exterior and the interior of the vehicle, the sensors would send notifications and alerts to the user's cellular phone. The cellular phone would be programmed with predetermined threshold levels of carbon monoxide. Once the threshold level of carbon monoxide is detected from the sensors, the cellular phone would automatically shut off the vehicle's ignition and the sensors would also send a signal to the cellular phone to alert the user, such that the user does not try to restart the vehicle's ignition.

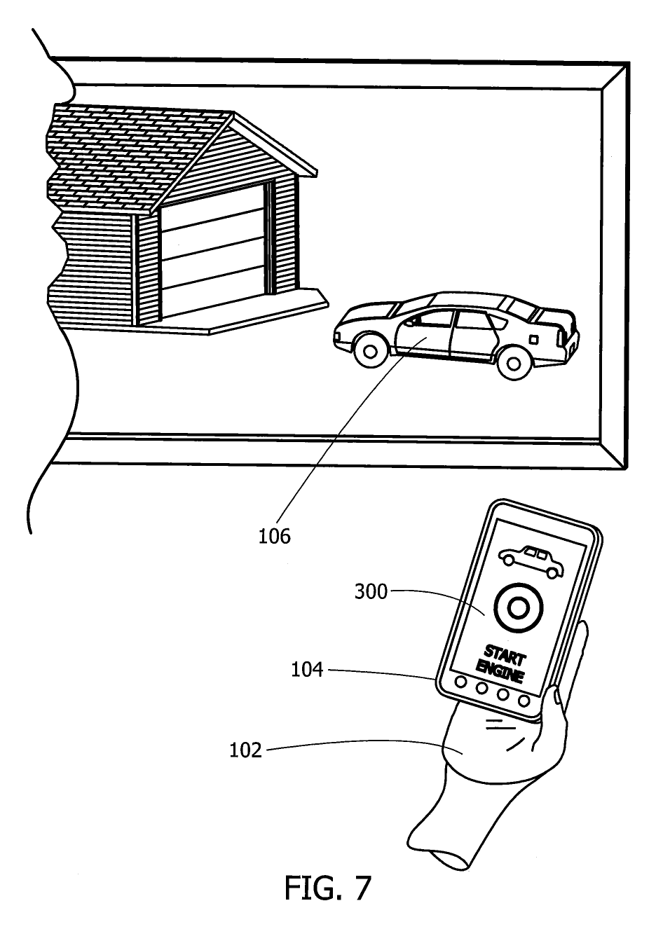

FIG. 7 illustrates the system 100 for controlling vehicle systems from a cellular phone in use. As shown, a user 102 establishes a connection with the vehicle system of the vehicle 106. Specifically, the transceiver of the cellular phone 104 transmits a signal to the vehicle system, and the transceiver of the vehicle system receives the transmitted signal. The cellular phone 104 and vehicle 106 are configured to communicate by linking the communications system of the cellular phone 104 and the vehicle system. For example, an application may be downloaded on the cellular phone 104, and/or a unique identifier for both the cellular phone 104 and the vehicle 106 may be registered with each of the respective devices to enable secure communications. Once communication is established between the cellular phone 104 and the vehicle system of the vehicle 106, the user 102 enters a user input into the user interface 300 of the cellular phone 104. The user input is linked to at least one command. The command is then translated into a vehicle action. The user interface 300 then requests authentication of the user input before transmitting the command to the vehicle system. The user authenticates the user input and a signal is sent to perform the vehicle action. The vehicle action is performed and the vehicle system then emits a signal back to the cellular phone. The signal alerts the user 102 that the vehicle action has been performed.

Included herein is a flow chart representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

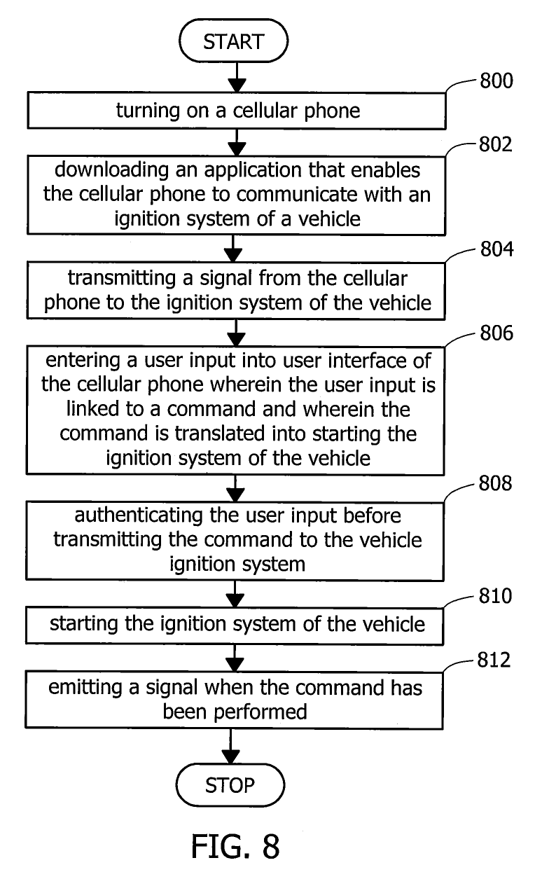

FIG. 8 illustrates a method of remote starting a vehicle. At 800, the cellular phone is turned on. At 802, an application that enables the cellular phone to communicate with an ignition system of a vehicle is downloaded. At 804, a signal is transmitted from the cellular phone to the ignition system of the vehicle. At 806, user input is entered into the user interface of the cellular phone. The user input is linked to at least one command and the command is translated into starting the ignition system of the vehicle. At 808, the user input is authenticated before transmitting the command to the vehicle ignition system. At 810, the ignition system of the vehicle is started. And at 812, a signal is emitted when the command has been performed.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for controlling vehicle systems via a cellular phone, comprising:
a vehicle comprising a vehicle system; and
a cellular phone comprising a user interface in communication with the vehicle system,
wherein a user can use the user interface to control at least one vehicle action.

2. The system of claim 1, wherein the vehicle system comprises a transceiver for receiving a signal from the cellular phone.

3. The system of claim 2, wherein the cellular phone comprises a transceiver for transmitting a signal to the vehicle system.

4. The system of claim 3, wherein a wireless connection is established between the vehicle system and the cellular phone via the vehicle system transceiver and the cellular phone transceiver.

5. The system of claim 1, wherein the user interface is operable to receive user input.

6. The system of claim 5, wherein the user input comprises at least one of a keyed entry, a voice command, or a button depression.

7. The system of claim 6, wherein the user interface links the user input to at least one user command.

8. The system of claim 7, wherein the at least one user command is operable to translate into at least one vehicle action.

9. The system of claim 8, wherein the at least one vehicle action comprises at least one of turning on and off an ignition system of the vehicle, locking or unlocking doors on the vehicle, rolling up or down windows of the vehicle, turning on vehicle lights, repositioning a vehicle seat, turning on windshield wipers of the vehicle, or controlling a user's pre-sets for the vehicle.

10. The system of claim 9, further comprising an identifier for authenticating the user input before transmitting at least one command to the vehicle system.

11. The system of claim 10, wherein the cellular phone emits a signal when the at least one command has been performed.

12. The system of claim 11, wherein the signal is a beep, a buzz, a vibration or a ring.

13. The system of claim 1, wherein the vehicle further comprises an emergency stop button.

14. The system of claim 1, wherein the vehicle further comprises at least one carbon monoxide sensor.

15. A remote starting system, comprising:
a vehicle comprising a vehicle system and a transceiver; and
a cellular phone comprising a user interface in communication with the vehicle system and a transceiver for transmitting signals to the vehicle system transceiver, and
wherein the vehicle system is in wireless communication with the cellular phone.

16. The remote starting system of claim 15, wherein the user interface is operable to receive user input, wherein the user input comprises at least one of a keyed entry, a voice command, or a button depression.

17. The remote starting system of claim 16, wherein the user interface links the user input to at least one user command.

18. The remote starting system of claim 17, wherein the at least one user command is operable to translate into at least one vehicle action.

19. The remote starting system of claim 18, wherein the at least one vehicle action comprises at least one of turning on and off an ignition system of the vehicle, locking or unlocking doors of the vehicle, rolling up or down windows of the vehicle, turning on vehicle lights, repositioning a vehicle seat, turning on windshield wipers of the vehicle or controlling a user's pre-sets for the vehicle.

20. A method of remote starting a vehicle, comprising:
turning on a cellular phone;
downloading an application that enables the cellular phone to communicate with an ignition system of a vehicle;
transmitting a signal from the cellular phone to the ignition system of the vehicle;
entering a user input into user interface of the cellular phone, wherein the user input is linked to at least one command and wherein the at least one command is translated into starting the ignition system of the vehicle;
authenticating the user input before transmitting the at least one command to the vehicle ignition system;
starting the ignition system of the vehicle; and
emitting a signal when the at least one command has been performed.
